(19) United States
(12) Patent Application Publication
(10) Pub. No.: US 2022/0307508 A1
(43) Pub. Date: Sep. 29, 2022

(54) METHOD FOR THE QUANTITATIVE DETERMINATION OF A CURRENT OPERATING STATE-DEPENDENT VARIABLE OF A FAN, IN PARTICULAR A PRESSURE CHANGE OR PRESSURE INCREASE, AND FAN

(71) Applicant: ZIEHL-ABEGG SE, Künzelsau (DE)

(72) Inventors: Frieder LOERCHER, Braunsbach (DE); Walter ANGELIS, Schwabisch Hall (DE)

(21) Appl. No.: 17/635,814

(22) PCT Filed: Jul. 2, 2020
(86) PCT No.: PCT/DE2020/200054

§ 371 Date: Feb. 16, 2022

(30) Foreign Application Priority Data
Aug. 17, 2019 (DE) 10 2019 212 325.2

(51) Int. Cl. F04D 27/00; F04D 29/28

(52) U.S. Cl. CPC F04D 27/001; F04D 27/004; F04D 29/281; F05D 2270/304; F05D 2270/3061; F05D 2270/3015

(57) ABSTRACT

Method for the quantitative determination of a current operating state-dependent variable, for example the pressure increase, of a fan, wherein, given a known volume or mass flow of the fan, a current operating state-dependent variable is determined via its rotational speed.

### CROSS-REFERENCE TO RELATED APPLICATIONS

This application is a national stage entry application under 35 U.S.C. 371 of PCT Patent Application No. PCT/DE2020/200054, filed 2 Jul. 2020, which claims priority to German Patent Application No. 10 2019 212 325.2, filed 17 Aug. 2019, the entire contents of each of which are incorporated herein by reference.

### FIELD

The present disclosure relates to a method for quantitative determination of current operating state-dependent variables of a fan during operation, such as the pressure change, in particular the pressure increase, and to a fan in which a quantitative determination of at least one current operating state-dependent variable, such as the pressure change, in particular the pressure increase, is carried out during operation.

### BACKGROUND

Knowledge of current operating state-dependent variables can be of multiple benefits. For example, the fan can be controlled or regulated depending on one or more of these variables. A higher-level system in which the fan is installed and operated can also be controlled or regulated depending on one or more of these variables. Furthermore, these variables can be recorded or integrated over time and used in a variety of ways.

When operating fans, for example, knowledge of a current pressure increase is desirable. Knowledge of the current pressure increase can be used to advantage. Users can use it to monitor or check the current status of an air handling system, for example the icing condition of a heat exchanger, the degree of clogging of a filter, critical damper states or current wind loads.

On the fan side, if the pressure increase is known, the pressure reserve of a fan that is susceptible to breakage, for example, can be monitored. It is possible to determine whether a fan is operating within a permissible operating range, for example, also to determine whether a so-called drum rotor is operating at too low a pressure.

From the prior art known from practice, it is already known to determine the pressure increase via differential pressure sensors. This is time-consuming and usually cannot be done directly on the fan. In most cases, elaborate piping or electrical wiring is required.

Another disadvantage of pressure differential determination via pressure sensors is the dependence of the measured differential pressure on the position of the pressure sensors and the associated problem of where and how to accommodate or mount such pressure sensors.

From the prior art it is also already known to determine the volume flow rate via the shaft torque in the case of backward curved radial impellers, via differential pressure measurements at the inlet nozzle or via impeller anemometers or thermal anemometers.

According to the preceding embodiments, the determination of the pressure change or pressure increase of a fan with pressure sensors is possible, in particular also a speed monitoring or torque monitoring of a fan, in order to be able to determine indirectly the clogging of filters or the icing.

The determination of current sound emissions of a fan can be used, for example, to control a fan in such a way that a certain prescribed limit value for the sound emission is not exceeded.

The determination of a current drive torque of a fan can be used to control a fan in such a way that a certain limit drive torque is not exceeded, for example in order not to overload the drive motor.

The determination of a current efficiency of a fan can be used to control a system with one fan or with several fans in such a way that the highest possible efficiency is achieved.

For the printed prior art, reference is made to DE 10 2013 204 137 A1 by way of example. A method for determining an operating state of the fan of a cooker hood is known from this publication. It is defined as a function of speed and power consumption of the electric motor. However, measuring the air volume flow via the motor torque is not possible with backward curved fans.

### SUMMARY

It is therefore the object of the present disclosure to specify a method for the quantitative determination of current operating state-dependent variables of a fan in operation, for example the pressure change or pressure increase, according to which the respective current operating state-dependent variable, for example the pressure change or pressure increase, of the fan is possible with sufficiently good accuracy without the use of complex sensors such as pressure sensors, without restriction to certain fans.

The above object is solved by the features of patent claim 1 and, with regard to a fan, by the features of the subsidiary patent claim 14, according to which, given a known volume or mass flow of the fan, current operating state-dependent variables, such as pressure change or pressure increase, are determined quantitatively via its rotational speed.

With regard to a determination of the current pressure increase, the disclosure is based on the fundamental idea/knowledge that the fan “infallibly” measures the pressure change or pressure increase occurring at it, since it must apply the necessary power to overcome, for example, the pressure increase.

In an arrangement, the user or a higher-level system can read out the determined current operating state-dependent variable, such as the pressure change or the pressure increase, and use it to control the fan or to control a complete ventilation system. The current operating state-dependent variable or its temporal progression may also be used to define a time for maintenance, cleaning or deicing of the ventilation system or one or more components of such a ventilation system.

In one embodiment according to the disclosure, the fan can determine and output the back pressure acting on it during a pressure increase without the aid of pressure sensors. This back pressure is determined at the fan, e.g., at the “source”, where the pressure increase is created or generated by whatever means. Compared to the use of an external pressure sensor system, measurement errors and susceptibilities of the measuring equipment related to the sensor system are eliminated. This applies in particular with regard to dependencies of the measurement results on the selected position of the respective pressure sensors and the current flow situation at or around the pressure sensors. This involves, for example, detachments and swirls that can occur under certain operating conditions. Probabilities of failure of the pressure sensors as well as the wiring or data transmission between the pressure sensors and an electronic system are eliminated.

The teaching according to the present disclosure is based on a determination of the air volume flow or air mass flow of the fan according to a method with high accuracy, based on an analysis of a flow velocity field. Then the current operating state-dependent variable of the fan, for example the fan pressure increase, is determined by taking into account the current speed, possibly measured or estimated information about the current density and a characteristic curve stored on the fan.

In the case of a fan that can be controlled by default to a constant volume flow or mass flow, it is not necessary to determine the air volume flow or air mass flow via a sensor, since the specified volume flow or mass flow can be used directly. However, a fan with the possibility of such constant volume flow control or constant mass flow control is usually still based on a sensor for direct or indirect determination of the volume or mass flow.

In contrast to the state of the art, the determination of the current operating state-dependent variable, for example the pressure change, in particular the pressure increase, of a fan is carried out without, for example, complex sensors such as pressure sensors, sound sensors or torque sensors and in this case close to the fan, wherein an upstream determination of the current air volume flow with the highest possible accuracy is required. Only one sensor may be required for direct or indirect determination of the air volume flow or the air mass flow.

If the volume or mass flow of the fan is known, the speed is used to determine the current operating state-dependent variable, such as the pressure increase, acoustic emission, drive torque, drive power, efficiency, vibration or axial thrust. The influence of the current air density of the current ambient temperature or the current air humidity, can be taken into account. The determination of the volume flow is carried out in advance with a method known from practice with high accuracy. To determine the current operating state-dependent variable, for example the pressure increase or pressure change, it is typically necessary that at least one calibration characteristic curve is stored on the fan for each operating state-dependent variable of interest. A calibration characteristic curve essentially represents a functional relationship between the volumetric flow rate or mass flow rate and a useful operating state-dependent variable for a specific speed or speed curve and a specific density (for example, pressure increase Δp as a function of volumetric flow rate \dot{V} at a specific constant speed and density). The use of an equivalent characteristic curve, for example, a conversion between static pressure increase and total pressure increase can also take place if the air volume flow or air mass flow is known anyway.

The fan can control itself with the calculated current operating state-dependent variable. For example, speed control is possible as a function of a currently determined pressure increase.

The pressure increase or another current operating state-dependent variable can be read out by a user or a higher-level system, so that the user or the higher-level system can control or otherwise influence the fan speed or the ventilation system based on this information.

The current operating state-dependent variable or its time history can also be stored and/or transmitted to the user or the fan manufacturer in order to be able to carry out further optimizations. This can be helpful in the basic selection of the fan or in the design optimization or technical optimization of the fan.

Pressure increase/pressure change Δp can generally be understood as a static pressure increase (Total-to-Static) or a total pressure increase (Total-to-Total), or another definition of pressure increase according to requirements. Only the calibration characteristic curve that can be used to determine the desired pressure increase must be determined and stored on the fan.

In general, the method can be used to determine a current operating state-dependent variable as long as the speed dependence of the target variable is at least approximately known. For example, it is possible to determine the pressure increase (approximately proportional n\hat{ }2), the drive torque (approximately proportional n\hat{ }2), the acoustic emission (approximately proportional n\hat{ }[4 . . . 6]), the axial thrust (approximately proportional n\hat{ }2) or vibration variables (in this case, dependence on n would have to be determined specifically for the fan). Derived operating state-dependent characteristic curve values can also be determined, for example the drive power using the speed and the drive torque, or the efficiency using the air volume flow, a pressure increase and the drive power. In each case, corresponding calibration characteristics must be determined and stored on the fan.

There are now various ways in which the teachings of the present disclosure can be embodied and further developed. For this purpose, reference is made on the one hand to the claims subordinate to claim 1 and on the other hand to the following explanation of exemplary embodiments of the method according to the disclosure or of a fan using this process on the basis of the drawings. In connection with the explanation of the exemplary embodiments of the disclosure with reference to the drawing, embodiments and further developments of the teaching are also explained.

### BRIEF DESCRIPTION OF THE SEVERAL VIEWS OF THE DRAWINGS

FIG. 1 a diagram in which two characteristic curves of a pressure increase Δp are shown, each as a function of a delivery volume flow \dot{V}, for a fan at a certain delivery density for two different, respectively constant speeds,

FIG. 2 a diagram showing four pressure increase curves Δp as a function of speed n for a fan at a specific fluid density for four different flow rates,

FIG. 3 in a perspective view and in section viewed in a plane through the axis of rotation of the impeller, an embodiment of a fan, wherein the determination of a current operating state-dependent variable is carried out with the aid of a conveying medium volume flow \dot{V} precisely determined by means of an impeller anemometer.

### DETAILED DESCRIPTION OF THE DISCLOSURE

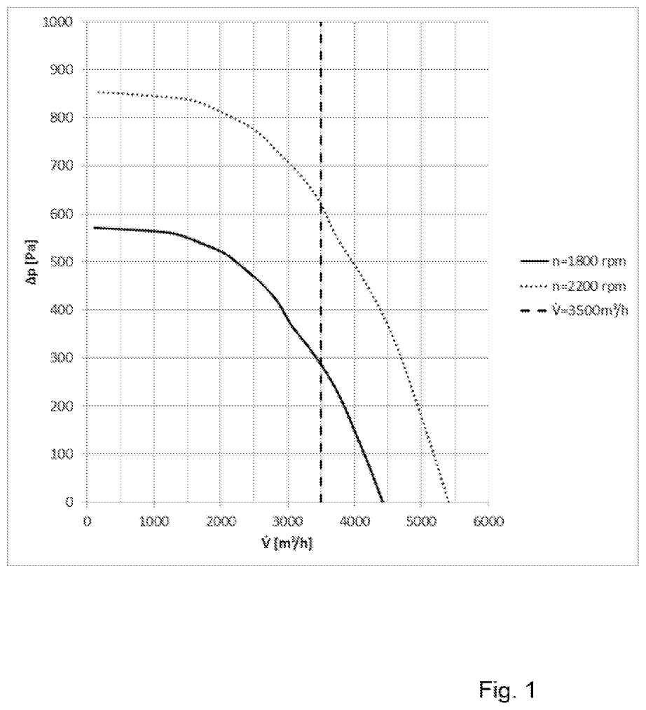

In FIG. 1, two characteristic curves of a pressure increase Δp of an exemplary fan over its conveying air volume flow \dot{V} are shown in a diagram for two different constant speeds n in each case. The characteristic curves are merely exemplary. They were determined based on the experimental measurement of a specific fan and may differ quantitatively and also in terms of the curve depending on the fan. In general, the characteristic curve of a pressure increase Δp is a functional relationship between a volume flow \dot{V} or a mass flow \dot{m} and a pressure increase Op, which is often specified at constant speed, but can also be specified at a defined variable speed curve. With a known volumetric flow rate \dot{V} or mass flow rate \dot{m}, the pressure increase Δp can be determined from the characteristic curve, provided that the current speed corresponds to the speed on which the characteristic curve is based. It can be seen that the pressure increase Δp depends quantitatively on the flow rate \dot{V}, i.e. in this sense it is an operating state-dependent variable.

Correspondingly, characteristic curves for other operating state-dependent variables can be determined and stored for specific speeds or speed curves. These other operating state-dependent variables can then also be determined with the aid of the corresponding characteristic curve with a known delivery volume flow or delivery mass flow.

FIG. 1 shows two characteristic curves, each at a constant speed n, as well as a line for a constant volume flow \dot{V}. Generally, it is sufficient to determine only one characteristic curve for a specific speed in order to determine a fan pressure increase Δp. The other can be obtained by conversion, as is also done in this example. Here, one uses the similarity laws for a fixed fan geometry, according to which \dot{V}˜n and Δp˜n² applies. If a characteristic curve is stored for a speed n, the pressure increase Δp can be determined as follows for a known volume flow \dot{V} and a known speed n:
1. Calculation of the characteristic curve (e.g. in the form of Δp(\dot{V})) for the current speed n from the stored calibration characteristic curve (example: calibration characteristic curve for n_calibration=1800 rpm, current speed n=2200 rpm),
2. Determination of the intersection point of the calculated characteristic curve for the current speed n with the line of the constant, currently determined volume flow \dot{V},
3. Reading of the current pressure increase Δp at the intersection point.
   In addition, the density effect can be taken into account, wherein the pressure increase is proportional to the density. For this purpose, the ratio of the current density to the density corresponding to the calibration characteristic curve may be determined or estimated.

Accordingly, other operating state-dependent variables can also be determined, in particular via the conveying volume flow or conveying mass flow and the current speed. Only a calibration characteristic curve need be stored, which enables calculation of the desired target value. It should be noted that different target variables have different dependencies on the speed n, which must be taken into account in the respective form.

In practice, a pressure increase or other operating state-dependent variables of the fan may be affected by the fan installation environment. In an embodiment, a correction factor or a correction function depending on the installation situation can be taken into account when determining the pressure increase or another variable depending on the operating state-dependent variable. Alternatively, the calibration characteristic curve can be determined in the installation situation or in a configuration that models the installation situation, and stored on the fan and used to determine the operating state-dependent variable. In order to achieve the most accurate determination of a current operating state-dependent variable, the current delivery volume flow \dot{V} or the current mass flow \dot{m} in particular may be determined with the highest possible accuracy. Particularly in areas where the characteristic curves are steep in a representation according to FIG. 1, small errors in the determination of the delivery volume flow \dot{V} or the delivery mass flow \dot{m} can already lead to relatively large errors in the operating state-dependent variable calculated from them. An accuracy of the volumetric flow/mass flow determination of no more than 5% deviation from the actual value is advantageous, in the case of special accuracy requirements of no more than 2% deviation from the actual value of the current delivery volumetric flow/mass flow. It has been shown that such high accuracy requirements for volume flow/mass flow determination are met in particular with methods based on an analysis of the flow velocity field at a suitable point in the area of the fan. As an example, such methods are based on the speed measurement of an impeller anemometer.

It has also been shown that time averaging of the determined volumetric flow \dot{V} or mass flow \dot{m} and/or the determined operating state-dependent variable over a few seconds, for example >=10 s, is advantageous.

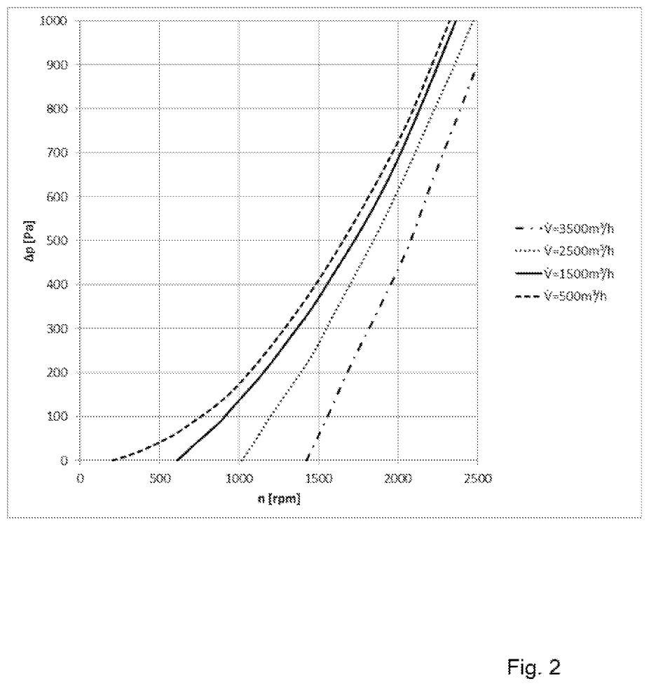

In FIG. 2, for a specific exemplary fan, a pressure increase Δp as a function of speed n is shown for several exemplary constant volume flows \dot{V} in each case. Such a representation can be derived solely from a known calibration characteristic, similar to that described in FIG. 1, and a known speed dependence of the target variable, here Δp. It is easy to see that for a known volume flow \dot{V} and a known speed n, the pressure increase Δp can be inferred unambiguously. Here, too, the correction of the pressure increase with density may be carried out in the same way as in FIG. 1.

The method for determining the pressure increase Δp works accordingly if the mass flow \dot{m} is used instead of the volumetric flow \dot{V}, except that the effect of the medium density is then already included in the mass flow \dot{m}. Then, instead of determining the volumetric flow \dot{V} in the method, the mass flow \dot{m} is determined using a known method. A density correction of the pressure increase Δp is no longer necessary. A calibration characteristic curve can be stored on the fan which describes a functional relationship of the mass flow \dot{m} and the volume flow \dot{V}, for example at constant speed. The methods for mass flow determination are essentially similar to the methods for volume flow determination. For example, the mass flow \dot{m} can be determined with an impeller anemomenter, but in addition to the anemometer speed, the current medium density may also be determined or estimated and included in the mass flow calculation.

Representations similar to those shown in FIG. 2 can also be drawn up for operating state-dependent target variables other than a pressure increase Δp. It should be taken into account that the speed dependence is of different nature for different targets. Speed dependencies can in many cases be derived from general fan laws, for example pressure increase, drive torque or axial thrust are proportional to the square of the speed to a very good approximation. The air volume flow or air mass flow may be scaled as linear to the speed. Sound power levels or sound pressures are proportional to the 4th to 6th power of the rotational speed. Furthermore, derived target variables can be formed from two or more target variables. For target variables where the speed dependence cannot be derived from general (fan) laws, speed dependencies can also be estimated on the basis of tests or simulations.

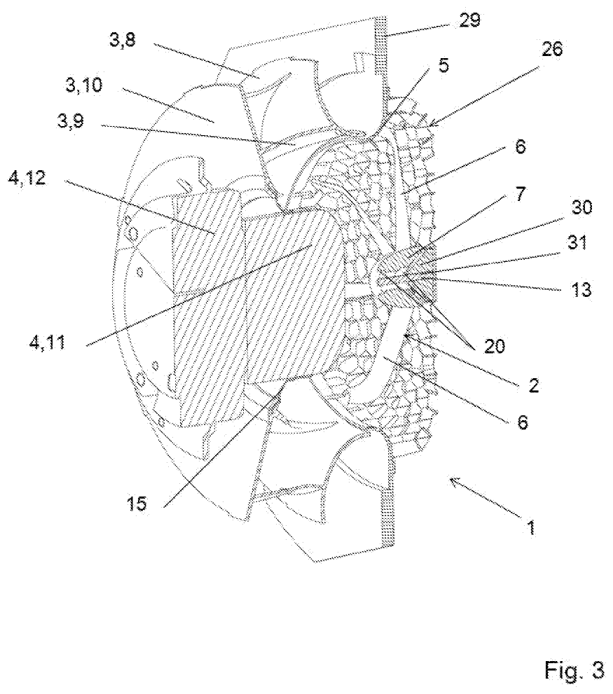

FIG. 3 shows a perspective view and a sectional view of an embodiment of a fan 1 as seen in a plane through the axis of rotation of the impeller 3, wherein the determination of the current operating state-dependent variable is carried out with the aid of a flow rate \dot{V} precisely determined by means of a volume flow measuring wheel 2. In particular, the volume flow measuring wheel 2 is constructed of a hub 7 and blades 6 mounted thereon. The illustration clearly shows the volume flow measuring wheel 2 and its mounting on a structure on the inflow side, in this case an inflow grille 26. An axis 13 for mounting the volume flow measuring wheel 2 is attached to the central area 30 of the inlet grille 26 via a mounting area 31.

The volume flow measuring wheel 2 is mounted on the axis 13 by means of bearings, in the embodiment example two bearings not shown are provided. The bearings are inserted on the volume flow measuring wheel 2 at receptacles 20 provided for this purpose inside the hub 7. The volumetric flow measuring wheel 2 can thus rotate freely with respect to the inlet grille 26 and independently of the rotor 11 of the motor 4 driving the impeller 3 of the fan 1. By measuring the speed of the volume flow measuring wheel 2, it is possible to infer the current conveying medium volumetric flow \dot{V} with good accuracy.

The impeller 3 of the fan 1 is attached to the rotor 11 of the motor 4 by means of a fastening device 15, which is designed as a sheet metal disk cast into the impeller 3 and pressed onto the rotor 11. The measurement and evaluation of the speed none of the volume flow measuring wheel 2 enables an accurate determination of the conveying medium volumetric flow \dot{V} with or without inclusion of the impeller speed n.

Once the flow rate \dot{V} has been determined, in an embodiment with the aid of electronics integrated in the stator 12 of the motor 4, the current operating state-dependent variable, for example a pressure increase Δp, is determined on this basis in the embodiment example, as described with reference to FIG. 1 and FIG. 2. The speed n of the impeller 3, which is constructed in particular of cover ring 8, hub ring 10 and impeller blades 9 extending between them, and thus the speed n of the motor 4, consisting in particular of a stator 12 and a rotor 11, may be known. It can be easily determined within the motor 4. Temperature or humidity sensors can be used to determine the current density of the pumped medium. Alternatively, the density can simply be estimated or passed to the motor 4 via an interface from a higher-level system.

In an embodiment, the motor 4 also has an interface for transferring at least one current operating state-dependent variable to a higher-level system. In a further embodiment, a time history of one or more operating state-dependent variables can be stored on the motor 4 in a suitable time resolution and read out as required.

For the sake of completeness, it should be mentioned that not all components of the fan 1 are shown in FIG. 3. In particular, a motor mount that attaches the stator 11 of the motor 4, for example, to the nozzle plate 29 is not shown for clarity. The fan 1 may include numerous other components not shown.

### LIST OF REFERENCE NUMBERS

1 Fan
2 Volume flow measuring wheel
3 Fan impeller
4 Motor
5 Inlet nozzle
6 Blade of a volume flow measuring wheel
7 Hub of a volume flow measuring wheel
8 Cover ring of an impeller
9 Impeller blades
10 Hub ring of an impeller
11 Rotor of a motor
12 Motor stator
13 Axis for the bearing of the volume flow measuring wheel
15 Fastening device of the impeller on the motor
20 Mounting in the volume flow measuring wheel for bearing
26 Inlet grille
29 Nozzle plate
30 Central area of the inlet grille
31 Receiving area for shaft in inlet grille

1. A method for the quantitative determination of a current operating state-dependent variable of a fan, comprising:
determining a current operating state-dependent variable via its rotational speed, given a known volume or mass flow of the fan.

2. The method according to claim 1, wherein the volume or mass flow is determined in advance according to a known method.

3. The method according to claim 1, wherein a calibration characteristic curve is stored on the fan for a specific speed or a specific speed curve, wherein the calibration characteristic curve describes a functional relationship between volume flow or mass flow and an operating state-dependent variable.

4. The method according to claim 1, wherein, given a known volume flow or mass flow and a known rotational speed, an operating state-dependent variable is calculated as follows:
calculation of at least one characteristic curve for the current speed from a stored calibration characteristic curve,
determination of the intersection point of a calculated characteristic curve for the current speed with a line of the constant, currently determined volume flow or mass flow, and
determining or reading of a current operating state-dependent variable at the intersection point.

5. The method according to claim 1, wherein an influence of a current air density is taken into account, wherein a pressure increase is proportional to the air density.

6. The method according to claim 1, wherein a current air density is measured, calculated or estimated.

7. The method according to claim 6 wherein, in order to take the air density into account, a ratio of the current air density to the air density corresponding to a stored calibration characteristic curve is determined or estimated.

8. The method according to claim 1, wherein a correction factor or a correction function is used to determine an operating state-dependent variable, which takes into account at least one of the installation situation and environment of the fan.

9. The method according to claim 1, wherein, for the determination of an operating state-dependent variable, a calibration characteristic curve is used which is obtained in an installation situation, a configuration modeling, or simulation of an installation situation and is stored on the fan.

10. The method according to claim 1, wherein one or more determined operating state-dependent variables are used for controlling or self-controlling the fan.

11. The method according to claim 10, wherein the self-control comprises speed control as a function of one or more operating state-dependent variables.

12. The method according to claim 1, wherein one or more operating state-dependent variables can be read out by a user or a higher-level system, wherein the user or the higher-level system can control or otherwise influence fan speed or a ventilation system on the basis of the one or more operating state-dependent variables.

13. The method according to claim 1, wherein, at least one of:
one or more operating state-dependent variables; and
a time course of one or more operating state-dependent variables;
is stored and/or forwarded to a user or a fan manufacturer to carry out optimizations on one of:
a selection of a specific fan;
design of the fan; and
a construction of the fan.

14. A fan comprising:
a quantitative determination of one or more operating state-dependent variables, wherein at least one current operating state-dependent variable can be determined for a known volume or mass flow of the fan via its rotational speed.
